(19) United States
(12) Patent Application Publication
(10) Pub. No.: US 2026/0148515 A1
(43) Pub. Date: May 28, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: TAKAHIRO MATSUURA, Tokyo (JP)

(21) Appl. No.: 19/384,083

(22) Filed: Nov. 10, 2025

(30) Foreign Application Priority Data
Nov. 26, 2024 (JP) 2024-205434

(51) Int. Cl. G06V 10/25

(52) U.S. Cl. CPC G06V 10/25; G06V 2201/07

(57) ABSTRACT

An image processing apparatus includes at least one processor and at least one memory having stored thereon instructions which, when executed by the at least one processor, cause the image processing apparatus at least to input image data of a captured image, to calculate a value indicating a focus degree of an object included in the image based on image capture information during a process for capturing the image with respect to the input image data, to output the value indicating the focus degree, and to determine a focus state of the object based on the value indicating the focus degree.

### BACKGROUND

### Field of the Technology

The present disclosure relates to a technology for quantifying and determining a focus degree of a subject based on a captured image and image capture information.

### Description of the Related Art

Recently, the total number of captured images in a single image capture process has increased dramatically with the improvement of continuous image capture performance of digital cameras. As a result, the work to extract the most focused image when images are sorted after the image capture process is time-consuming, which is a significant burden on professional photographers and general users.

In Japanese Patent Laid-Open No. 2021-26371, an original image is converted into a spectrum in a spatial frequency domain, and data obtained by integrating the converted image in an angle direction is approximated by a sigmoid function, and an evaluation value indicating the quality of the image is calculated from a parameter indicating an inflection point, such that a degree of blurriness is evaluated.

However, in Japanese Patent Laid-Open No. 2021-26371, the evaluation is possible when a continuous image capture process is performed or in the case of the same composition in which the geometric conditions do not change, but there is a problem because the evaluation is impossible in the same index when the image capture lens (also referred to as a lens unit) used for a different composition or image capture process is different. Moreover, because the evaluation is performed from the entire image, there is a problem that it is not possible to accurately evaluate an image with a composition that is in focus in a part thereof.

### SUMMARY

The present disclosure has been made in view of the above problems, and the present disclosure is directed to provide technology for evaluating a focus degree in the same index even if an image capture process is performed under a different condition for a specific object within an image.

According to an aspect of the present disclosure, there is provided an image processing apparatus including: at least one processor; and at least one memory having stored thereon instructions which, when executed by the at least one processor, cause the image processing apparatus at least to: input image data of a captured image; calculate a value indicating a focus degree of an object included in the image based on image capture information during a process for capturing the image with respect to the input image data; output the value indicating the focus degree; and determine a focus state of the object based on the value indicating the focus degree.

Further features of the present disclosure will become apparent from the following description of exemplary embodiments (with reference to the attached drawings).

### BRIEF DESCRIPTION OF THE DRAWINGS

FIG. 1 is an example of a configuration of a system including an image processing apparatus according to a first embodiment.

FIG. 2 is a flowchart showing a flow of a process of the image processing apparatus shown in FIG. 1.

FIG. 3A is a flowchart showing a flow of a process of an object detection unit and FIG. 3B is a flowchart showing a flow of a process of a focus degree calculation unit.

FIG. 4 is a diagram showing an example in which an object is cropped.

FIG. 5 is a diagram showing visual characteristics (contrast response) of humans.

FIGS. 6A and 6B are examples of differential images of an in-focus time and an out-of-focus time.

FIG. 7 is an example of a user interface in which an image and an evaluation value are displayed.

FIG. 8 is an example of a configuration of a system including an image processing apparatus according to a second embodiment.

FIG. 9A is a flowchart showing a flow of a process of the image processing apparatus shown in FIG. 1 and FIG. 9B is a flowchart showing a flow of a process of a focus determination unit.

FIG. 10 is a diagram showing an example of a threshold surface.

FIG. 11 shows an example of a user interface in which an image, an evaluation value, and a determination result are displayed.

FIG. 12 is an example of a determination mode displayed on the display device according to a third embodiment.

FIG. 13 is an example of a determination mode displayed on the display device according to the third embodiment.

FIG. 14 is an example of a determination mode displayed on the display device according to the third embodiment.

### DESCRIPTION OF THE EMBODIMENTS

Hereafter, embodiments of the present disclosure will be described with reference to the drawings. The present disclosure is not limited to situations to be described below, and may be applied to any embodiment consistent with the subject matter of the present disclosure.

### First Embodiment

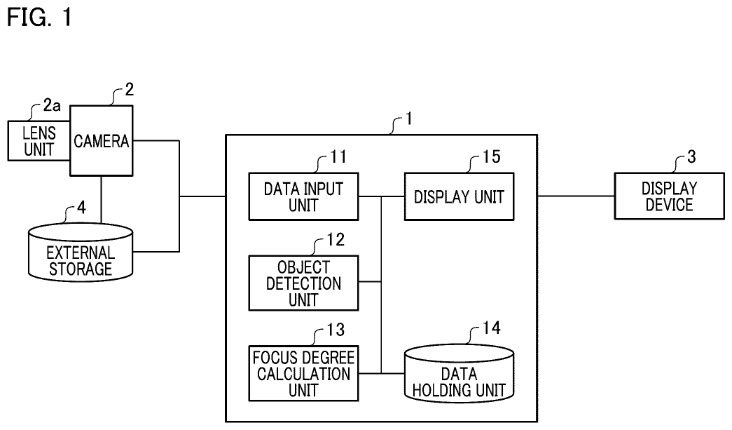

FIG. 1 shows an example of a configuration of a system including an image processing apparatus according to a first embodiment. The system shown in FIG. 1 includes an image processing apparatus 1, a camera 2, a display device 3, and an external storage 4.

The image processing apparatus 1 includes a data input unit 11, an object detection unit 12, a focus degree calculation unit 13, a data holding unit 14, and a display unit 15.

In the data input unit 11, image data is input from the camera 2. In other words, the data input unit 11 functions as an input unit through which the image data of the captured image is input. The object detection unit 12 detects and extracts an object from the image data input to the data input unit 11. The focus degree calculation unit 13 calculates a value indicating the focus degree of the detected object.

The data holding unit 14 holds the input image data, image capture information, the value indicating the focus degree calculated by the focus degree calculation unit 13, and the like. The data holding unit 14 also functions as a work memory for the process to be described below. In addition, the image capture information in the present embodiment is information about conditions at the time of an image capture process, such as lens characteristics, as described below, an environment, and settings, information obtained as a result of the image capture process, such as a pixel size, and the like. The display unit 15 generates screen data constituting image data, applications, and the like and causes the display device 3 to display the screen data. In other words, the display unit 15 functions as an output unit configured to output the value indicating the focus degree calculated by the focus degree calculation unit.

Functions of the data input unit 11, the object detection unit 12, the focus degree calculation unit 13, the data holding unit 14, and the display unit 15 described above, for example, are implemented by a central processing unit (CPU) executing a program stored in the memory of the image processing apparatus 1.

The camera 2 includes an interchangeable lens unit 2a (hereinafter referred to as a lens unit 2a). The lens unit 2a can be replaced in accordance with an application or the like. The camera 2 captures an image of the subject and transfers image data to the image processing apparatus 1 or the external storage 4. In addition, the transmission of image data can be wired communication or wireless communication.

The display device 3 displays the screen data output by the display unit 15, and, for example, can use a liquid crystal display or the like.

The external storage 4 holds image data as a hard disk drive (HDD) or the like. In addition, the external storage 4 may include a cloud storage accessed via the network or the like. Moreover, the external storage 4 may be able to be connected to the image processing apparatus 1.

### (Processing Flow of System)

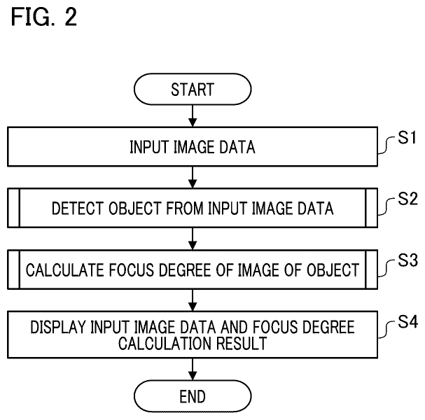

FIG. 2 is a flowchart showing a flow of a process (image processing method) of the image processing apparatus 1 shown in FIG. 1. In the present embodiment, a case where a size (the number of vertical/horizontal pixels) of the area including the object including the value calculation object indicating the focus degree on the image is used as image capture information, and frequency analysis is used to calculate the value indicating the focus degree will be described. In addition, the flowchart shown in FIG. 2 or the like can be implemented when a processing device such as the CPU provided in the image processing apparatus 1 reads and executes the program stored in a storage device such as a memory.

First, in step S1, image data of the image captured by the camera 2 or the image data held by the external storage 4 is input from the data input unit 11.

Subsequently, in step S2, the object detection unit 12 detects the object from the input image data. Details of the process of the object detection unit 12 will be described below.

Subsequently, in step S3, the focus degree calculation unit 13 calculates a value indicating the focus degree of the detected object. Details of the process of the focus degree calculation unit 13 will be described below.

Also, in step S4, the display unit 15 causes the display device 3 to display the image data and a result of calculating the value indicating the focus degree. Examples of display will be described below.

In other words, step S1 functions as the input process, steps S2 and S3 function as the focus degree calculation process, and step S4 functions as the output process.

### (Process of Object Detection Unit 12 in Step S2)

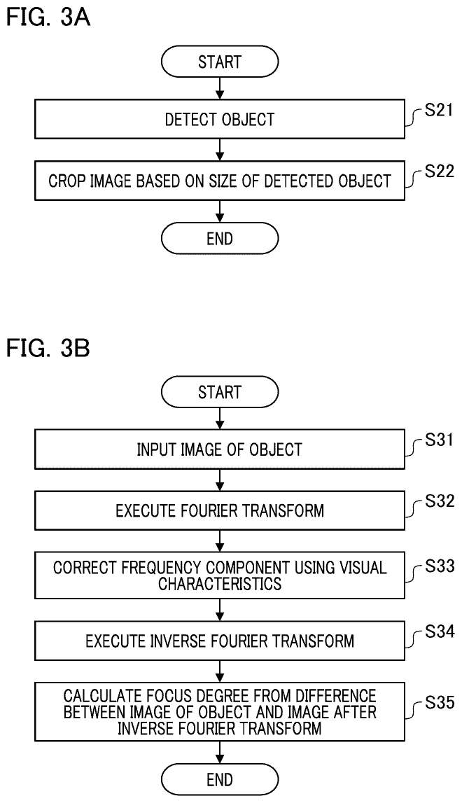

FIG. 3A is a flowchart showing a flow of a process of the object detection unit 12 in step S2 described above.

First, in step S21, the object is detected from the input image data. At the time of the detection, for example, if the object is a person's eye, it is only necessary to detect the person's eye closest to a focus point using a known person detection algorithm.

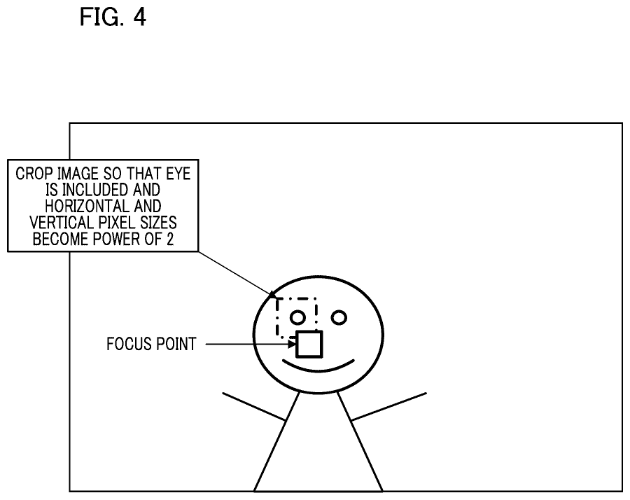

Subsequently, in step S22, an object such as a person's eye is detected from the input image data, and an area including the detected object is cropped (extracted). At the time of cropping, the eye closest to the focus point as shown in FIG. 4 is cropped. In the present embodiment, a size of the area to be cropped is a rectangle including the eye, and the image is cropped so that the vertical and horizontal pixel sizes become a power of 2, for example, 128 pixels×128 pixels. In addition, the vertical and horizontal pixel sizes (hereinafter referred to as a pixel size) of the area from which the object such as the eye is cropped are not limited to a power of 2.

In other words, the object detection unit 12 functions as an extraction unit for detecting the object from the image and extracting the area on the image including the object.

Moreover, the object is not limited to the eye of the person, and can also be the face, head, or whole body of the person, or the eyes, face, head, or whole body of an animal other than a person. In other words, the object may be a living organism or a specific part of an organism.

Although an example in which the position and pixel size of an object are decided using the object detection unit 12 has been described in the present flowchart, the user may designate information such as the position of the object and the pixel size in advance.

### (Process of Focus Degree Calculation Unit 13 in Step S3)

FIG. 3B is a flowchart showing a flow of a process of the focus degree calculation unit 13 in step S3 described above. An example in which a value indicating a focus degree based on frequency analysis is calculated will be described with reference to FIG. 3B.

First, in step S31, the image data of the area including the object cropped in step S2 is input.

Subsequently, in step S32, a Fourier transform is performed on input image data and a transform result is converted into data in a frequency domain.

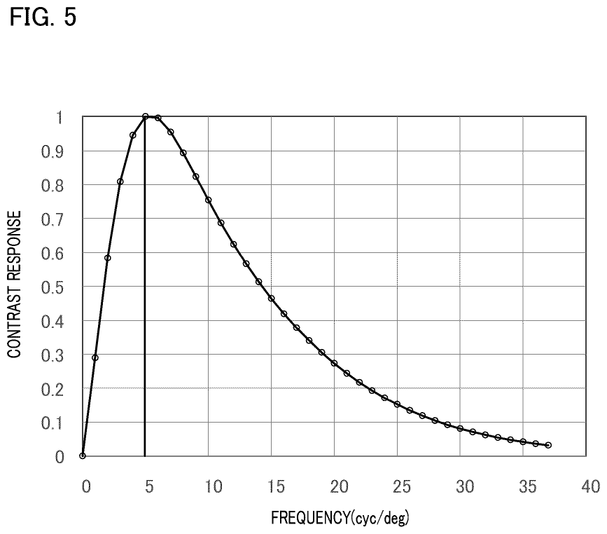

Subsequently, in step S33, the frequency component is modified using visual characteristics. For example, human visual characteristics (contrast response) are shown in FIG. 5. The human visual characteristics (contrast response) are known to be the most sensitive at 5 cyc/deg, as shown in FIG. 5. Here, if an observation distance is 400 mm, a distance per deg on the display located 400 mm ahead is calculated as shown in the following formula (1).

$$400 \times tan 1 deg = 6.98 \qquad ( 1 )$$

If it is assumed that the above display is a 24-inch full HD display (a horizontal length of 518 mm and 1920 pixels) in 6.98 mm/deg from formula (1), formula (2) is given.

$$1920 \times 6.98 \div 518 = 25.9 \qquad ( 2 )$$

Thus, on a 24-inch, full HD display with an observation distance of 400 mm, the distance per deg is equivalent to 25.9 pixels/deg.

From formula (2) and FIG. 5, assuming that 25.9 pixels correspond to 5 cycles, the line of 5.2 pixels/cyc represents the pixel count with the highest sensitivity. In other words, lines finer than this show lower sensitivity.

From the above, a cutoff frequency is 5.2 pixels/cyc, and a frequency higher than 5.2 pixels/cyc is cut. Specifically, a filtering process is executed to reduce the power of a frequency higher than 5.2 pixels/cyc to 0. In other words, the focus degree calculation unit 13 converts the area extracted by the extraction unit into a frequency band, and executes a filtering process according to visual characteristics for the frequency band after the conversion.

Returning to FIG. 3B, in step S34, an inverse Fourier transform (inverse fast Fourier transform (FFT)) is performed on data after frequency processing.

Also, in step S35, an absolute value of a difference between the image input in step S31 and the image obtained by executing the inverse Fourier transform in step S34 is calculated for each pixel. Also, a sum of absolute values of differences between pixels in the entire image (cropped image) is calculated as a value indicating the focus degree (hereinafter referred to as the focus degree).

When the focus degree is calculated, for example, it is only necessary to calculate an average value of pixel values of a G channel among RGB pixels. Alternatively, the average value may be calculated by calculating a luminance value L from each RGB pixel value using the following formula (3).

$$L = ( 3 R + 6 G + B ) / 10 \qquad ( 3 )$$

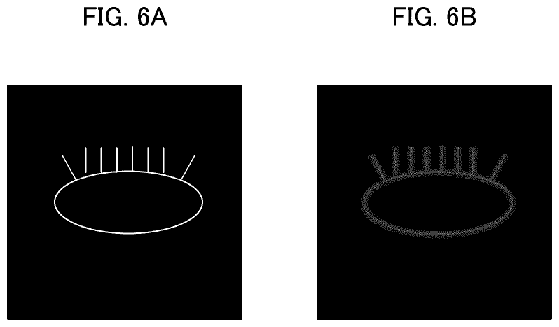

Examples of differential images are shown in FIGS. 6A and 6B. A differential image is an image obtained by calculating an absolute value of a difference between the image input in the above-described step S31 and the image obtained by executing the inverse Fourier transform in step S34 for each pixel.

This is a differential image when the image is in focus in FIG. 6A and the image is not excessively in focus in FIG. 6B. At the in-focus time, because the input image includes a large number of high-frequency components, a large number of high-frequency components are cut by the correction of the frequency component in step 533. If the result is applied to the inverse Fourier transform in step S34, the input image is output as an image with large blur. Therefore, the difference (the absolute value of the difference) becomes large. On the other hand, when the image is not excessively in focus, the difference is small because a large number of high-frequency components are not included. In this state, when the integral of the pixel values of the differential image (the sum of the values of the differences between the pixels in the entire image) is calculated, because the value of FIG. 6A that is in focus is larger, it is determined that a higher focus degree indicates a sharper focus.

Although the cutoff frequency has been decided according to the observation conditions and visual characteristics in the above example, the cutoff frequency can also be calculated in accordance with modulation transfer function (MTF) characteristics of the lens unit 2a. For example, when the maximum value of the MTF characteristic of the lens unit 2a is 0.8, because the resolution of the lens will decrease, the cutoff frequency should also be lower. Therefore, for example, in this case, it is only necessary to set the maximum value to 0.8 times. In other words, the filtering process can be executed in accordance with visual characteristics and image capture information (e.g., lens characteristics such as MTF characteristics) to calculate the value indicating the focus degree.

In this way, the focus degree calculation unit 13 functions as a focus degree calculation unit that calculates a value indicating the focus degree of the object included in the image based on the image capture information during the image capture process with respect to the image data input to the input unit.

### (Example of Display of Focus Calculation Result)

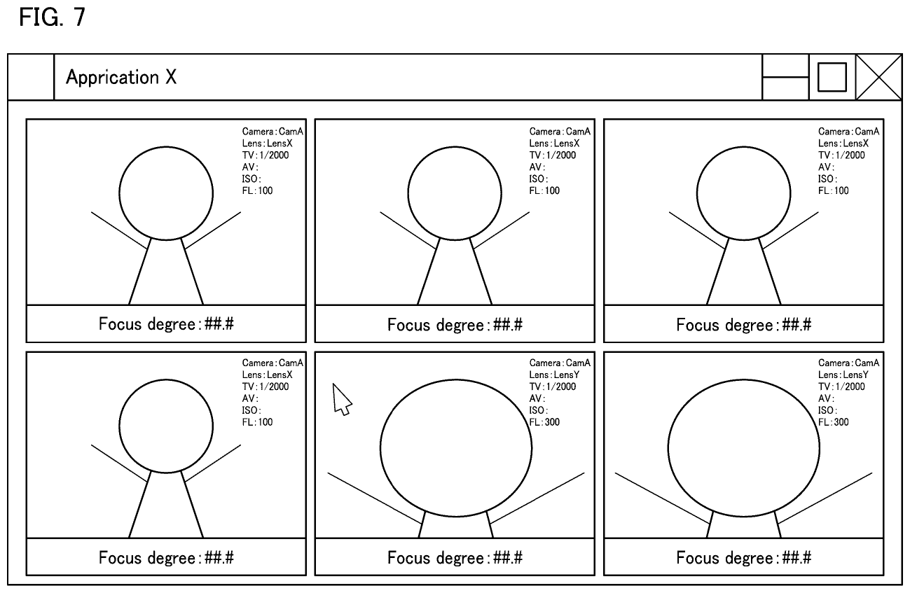

FIG. 7 is an example of a display of the result of calculating the focus degree displayed by the display device 3 in step S4. The display device 3 serves as a display unit that can display at least a value indicating the focus degree. In FIG. 7, a model name of the camera 2, a lens type of the lens unit 2a, a time value (TV or a shutter speed value), an aperture value (AV), ISO sensitivity, a focal length (FL), and a focus degree are displayed in association with the image.

By displaying the focus degree, a state of focus can be quantified and easily discriminated. For example, among the six images shown in FIG. 7, an image with the highest focus degree can be discriminated to be the most in focus.

Although the focus degree is displayed along with the image in the example of FIG. 7, the image may not be displayed. For example, the focus degree may be displayed in association with the file name of the image data. In other words, if the information is used to identify an image, the file name and the like as well as the display of the image itself may be used.

Although the image processing apparatus 1 uses the display unit 15 as the output unit and outputs the image data and the value indicating the focus degree to the display device 3 in the configuration of FIG. 1, the output destination of the output unit is not limited to the display. For example, the display unit 15 can be changed to an external interface such as a universal serial bus (USB) interface and the image data and the value can be output to a storage device such as an HDD. Alternatively, the display unit 15 may be changed to a network interface and the image data and the value can be output to a network such as the Internet.

### Modification Example

Although the focus degree is calculated by applying a filter considering visual characteristics from the frequency analysis results in the focus degree calculation unit 13 in the above-described embodiment, a machine learning model may be used instead. As the machine learning model, a convolutional neural network (CNN), a vision transformer (ViT), and the like can be used.

When the focus degree is calculated using the machine learning model, either regression or classification is used.

When regression is used, for example, the parameters of the machine learning model are adjusted so that the output is 1.0 for an image in focus with respect to the object, and 0.0 for an image out of focus with respect to the object. In this case, based on the focus degree, the correct values may be divided into a plurality of levels such as 1.0, 0.8, 0.6, 0.4, 0.2, and 0.0, and regression learning may be performed so that the outputs correspond to these values.

When classification is used, the model is trained to classify an image in focus with respect to the object as class 1 and an image out of focus with respect to the object as class 0. Although an example in which the focus level is classified into two classes, 1 and 0, has been described, learning may also be performed to classify images into a plurality of classes according to the focus degree.

Moreover, different machine learning models may be trained for each pixel size, and during inference, the learning model corresponding to the image size may be selected. Alternatively, different machine learning models may be trained for each type of lens in the lens unit 2a, and during inference, the model corresponding to the lens type may be selected. By doing so, the focus degree can be calculated more accurately.

According to the present embodiment, by analyzing the frequency of the image data and applying a filter considering the visual characteristics to calculate the focus degree, it is possible to evaluate the focus degree even if the conditions such as pixel size and lens type of the lens unit 2a are different.

### Second Embodiment

Next, an image processing apparatus according to a second embodiment will be described. In addition, descriptions of constituent elements identical to those of the first embodiment will be omitted, and the following description will mainly focus on portions different from the first embodiment.

In the first embodiment, the focus degree has been calculated by performing frequency analysis on image data and applying a filter considering visual characteristics. In the present embodiment, a threshold surface is set in consideration of a pixel size and MTF characteristics with respect to the calculation result, and the quality of the focus state is determined based on where the calculated focus degree lies within the surface. As an example of focus state determination, the state may be classified into four levels: “A: very well focused,” “B: focused,” “C: slightly out of focus,” and “D: out of focus.” However, the determination is not limited to these four levels, and the determination may be made in two levels such as “B: focused” and “D: out of focus,” or in three levels, five levels, or more. In short, it is only necessary to evaluate the focus state in a plurality of levels. The grades used for the determination may be expressed using numbers instead of letters.

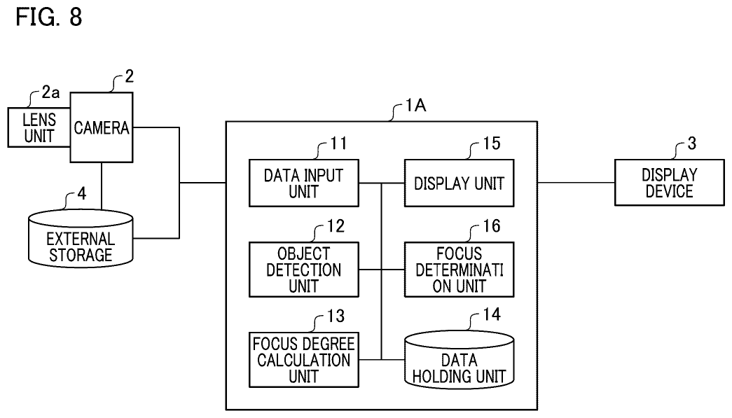

FIG. 8 is an example of a configuration of a system including the image processing apparatus according to the present embodiment. The system shown in FIG. 8 has the image processing apparatus 1 changed to the image processing apparatus 1A compared to FIG. 1. The image processing apparatus 1A has a focus determination unit 16 added to the image processing apparatus 1.

The focus determination unit 16 determines the focus state from image capture information such as the focus degree calculated by the focus degree calculation unit 13, the pixel size, and the lens characteristics. In other words, the focus determination unit 16 functions as a determination unit that determines the focus state of the object based on the value indicating the focus degree.

### (Processing Flow of System)

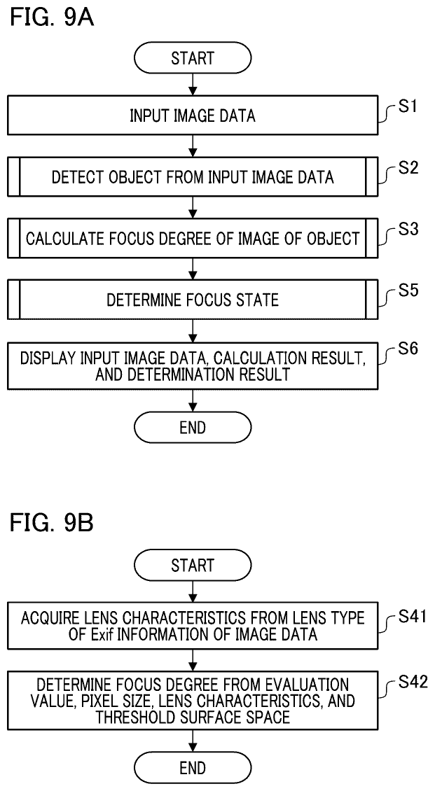

FIG. 9A is a flowchart showing a flow of a process of the image processing apparatus 1A shown in FIG. 8.

Because steps S1 to S3 are the same as those in FIG. 2, descriptions thereof will be omitted. In step S5, which follows step S3, the focus determination unit 16 executes the determination of the focus state of the object detected in step S2. Details of the process of the focus determination unit 16 will be described below.

Subsequently, in step S6, the display unit 15 causes the display device 3 to display the image data and the calculation result of the focus degree and the result of the determination performed in step S16. Examples of display will be described below.

### (Process of Focus Determination Unit 16)

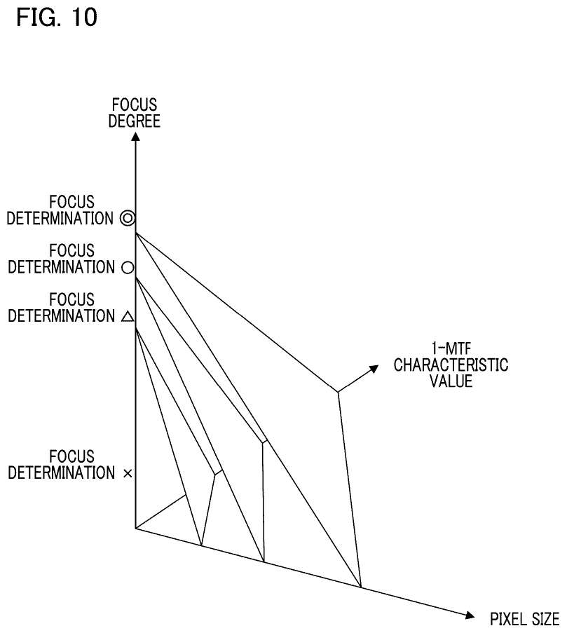

Next, the process of the above-described focus determination unit 16 will be explained. The focus state is determined from the focus degree calculated in step S3 of FIG. 9A, the lens characteristics of the lens unit 2a, and the pixel size. First, a threshold surface, such as that shown in FIG. 10, is created in advance. In creating the surface, several representative images are used, four levels are defined visually, for example, “A: very well focused,” “B: focused,” “C: slightly out of focus,” and “D: out of focus,” and a corresponding relationship between the focus degree calculated by the focus degree calculation unit 13 and the visual evaluation result may be calculated. At this time, the surface is created while varying pixel size and lens characteristics. Also, surfaces are formed at the boundary points between ‘A’ and ‘B,’ ‘B’ and ‘C,’ and ‘C’ and ‘D,’ and each of these is defined as a threshold surface. The created threshold surface data is stored in the data holding unit 14. Examples of the lens characteristics include MTF characteristics. Although these vary depending on the position within the image, for example, an average value of the central portion may be used. In this case, the lens characteristics such as MTF characteristics may be obtained from information disclosed in catalogs and the like or may be measured directly.

A process of the focus determination unit 16 (step S5) will be described using the flowchart in FIG. 9B.

First, in step S41, the lens type is acquired from exchangeable image file format (Exif) information of the captured image input in step S1, and the lens characteristics are acquired based on the acquired lens type. The lens characteristics can be held, for example, in the data holding unit 14.

Subsequently, in step S42, the focus state is determined based on the focus degree, pixel size, and lens characteristics. During the determination, the threshold surface shown in FIG. 10 is read from the data holding unit 14. In a space where the read threshold surface is defined, the focus degree calculated in step S3, the pixel size cropped in step S2, and the lens characteristics acquired in step S41 are plotted. Also, the determination of “A,” “B,” or the like described above is made based on which surfaces the plotted position lies between. If the plotted position lies on a surface, the higher evaluation is selected.

### (Example of Display of Focus Determination Result in Present Embodiment)

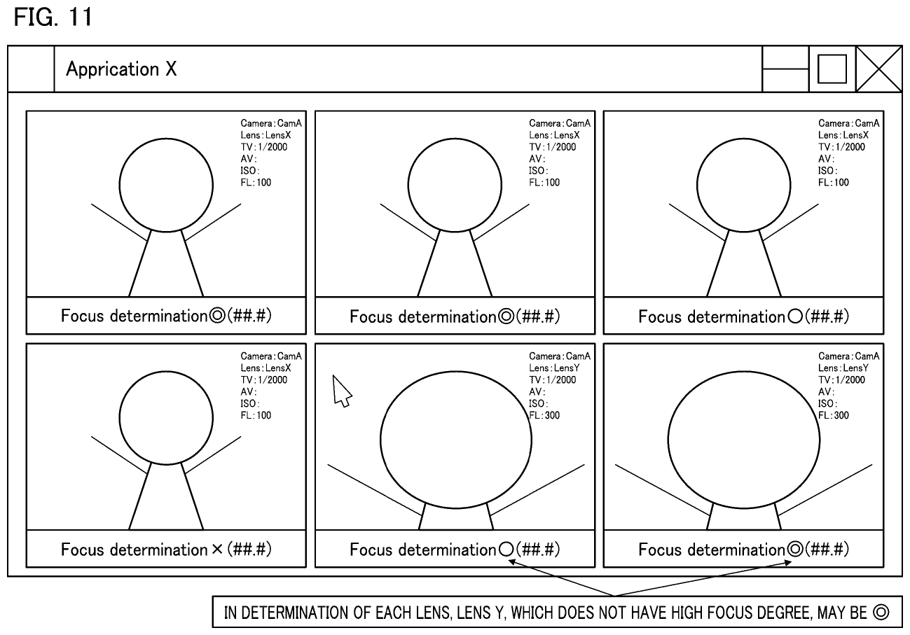

FIG. 11 shows an example of the display of the focus state determination result in step S6. The display example shown in FIG. 11 is generated by the display unit 15 and displayed on the display device 3. In FIG. 11, in addition to the focus degree shown in FIG. 7, a determination result of the focus determination unit 16 is also displayed. By displaying the determination result, it becomes easy to identify whether or not the lens unit 2a is well-focused for each lens type and pixel size, even if the focus degree is the same. In addition, only the determination result may be displayed without displaying the focus degree.

FIG. 11 shows three images in the upper row and the one image in the lower left captured using lens type X and the remaining two images in the lower row captured using lens type Y For example, the focus degree (##.#) of the images captured with lens Y may be lower than the focus degree (##.#) of the images captured with lens X. However, by using the threshold surface that incorporates the lens characteristics to determine the focus state, as shown in FIG. 11, the focus state may be determined as ‘A’ for lens y even though it does not have a high focus degree, in the determination of each lens type.

Although the lens characteristics have been described as MTF characteristics in the present embodiment, other characteristics, such as an aperture value (AV) or focal length, may also be used. In addition to the lens characteristics, other image capture information, such as TV (shutter speed value) or ISO sensitivity, may also be used.

Although the threshold surface has been set in a two-dimensional space defined by a pixel size and lens characteristics in the present embodiment, the present disclosure is not limited thereto. The threshold may be set in a one-dimensional space using only the pixel size or only the lens characteristics. Alternatively, in addition to information of the pixel size and lens characteristics (MTF characteristics), the threshold surface may be set in a three-dimensional space that includes, for example, lens characteristics (AV, focal length) or image capture information (TV, international organization for standardization (ISO) sensitivity), or even in a space of four or more dimensions. That is, the multiple-level determination thresholds for determining the focus state may be changed in accordance with the image capture information.

Moreover, a plurality of focus degree calculation units may be provided. One unit may calculate the focus degree based on frequency analysis, while another unit may calculate the focus degree based on machine learning, as described in a modification example of the first embodiment. Each focus degree may be handled in a two-dimensional space, and a threshold surface may be set accordingly.

Thus, by determining the focus state using a plurality of pieces of information, a more stable determination can be made than when using a single piece of information.

According to the present embodiment, the focus degree is quantified through frequency analysis that takes visual characteristics into account, and the quantified focus degree, together with the pixel size and the MTF characteristics of the lens unit 2a, is used to determine the focus state. As a result, it is possible to extract the most in-focus image regardless of the pixel size or the lens unit 2a.

### Third Embodiment

Next, an image processing apparatus according to a third embodiment will be described. In addition, descriptions of constituent elements identical to those of the first embodiment will be omitted, and the following description will mainly focus on portions different from the first and second embodiments.

In the first embodiment, quantification has been performed using the focus degree, and in the second embodiment, focus determination has been performed for each pixel size and lens characteristic using the threshold surface. In the present embodiment, an example in which the focus degree is determined for the whole lens rather than for each lens or in which only images captured with a specific lens are displayed will be described.

### (Example of Display of Focus Determination Result in Present Embodiment)

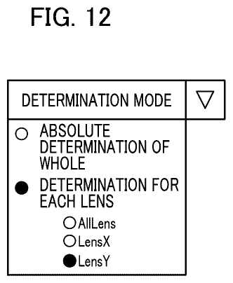

FIG. 12 shows an example in which a determination mode is selected. FIG. 12 is an example of a menu screen for determination modes displayed on the display device 3. As shown in FIG. 12, as the determination mode, it is only necessary to select the determination of the focus state of the entire set of images using absolute values (absolute determination), the display of all images captured with all lenses for each lens unit 2a, the display of only images captured with a specific lens type (lens X or lens Y), or the like. That is, the display device 3 can switch display content based on image capture information.

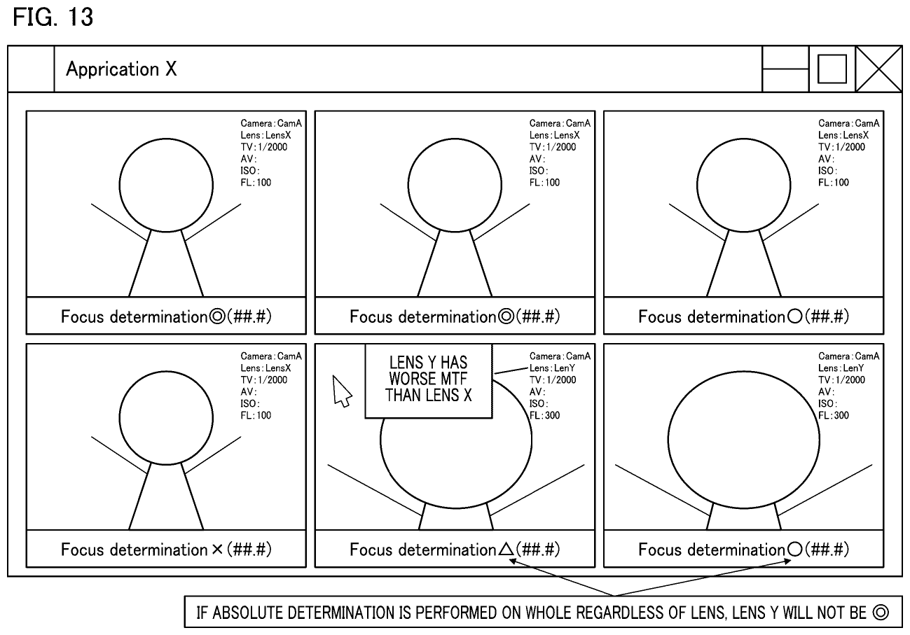

FIG. 13 shows an example of the display when the focus state is determined using absolute values. In the display example of FIG. 13, the focus degree and determination result are displayed on the display device 3 in association with the image. When the determination is performed using absolute values, the focus state is determined on the threshold surface shown in FIG. 10 with the MTF characteristic value fixed at 1.0, regardless of the type of lens unit 2a used for the image capture process (i.e., independent of the lens type). In other words, the determination conditions are changed between determining the focus state independent of the lens type of the lens unit 2a and determining the focus state for each lens unit 2a.

In this way, it becomes possible to perform determination using absolute values that are independent of the type of lens unit 2a used for an image capture process. That is, the focus determination unit 16 outputs a focus state determination result that does not depend on the lens unit 2a. When the determination is performed using absolute values, in the case of, for example, lens Y with relatively poor MTF characteristics, as shown in FIG. 13, because the focus degree is not high, even if it is the most in-focus image for that lens, the focus state determination may not result in “A” when all lenses including lens X are compared.

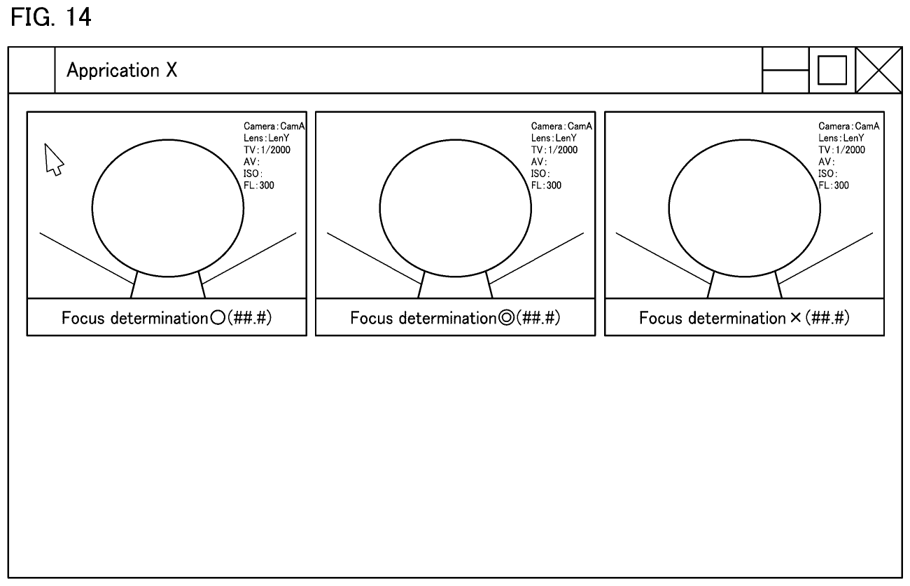

FIG. 14 shows an example in which only images captured with a specific lens unit 2a, for example, lens Y are displayed. In this case, because the focus state is determined according to the MTF characteristics of lens Y, it is possible to evaluate and display the images captured with the same lens type.

That is, in the present embodiment, it is possible to switch the determination result between the focus state determination result that is independent of the lens unit 2a as shown in FIG. 13 and the focus state determination result for each lens unit 2a as shown in FIG. 14 and display the switched determination result.

Moreover, “AllLens” in FIG. 12 refers to a display in which all determination results are displayed simultaneously when there are determination results for a plurality of lens types as shown in FIG. 11. That is, “AllLens” represents, for example, the display in FIG. 11 with the determination results added. In this case, as described with reference to FIG. 11, images captured with lens Y, which may have a lower focus degree than lens X, may be displayed with a determination result such as “A” or “B.”

According to the present embodiment, when a plurality of types of lens units 2a are used and a plurality of images are captured with each lens unit 2a, it is possible to switch the display between the display of the images that are in focus as the whole and the display of the images that are in focus for each lens unit 2a. As a result, a desired image can be easily identified.

The present disclosure can also be realized by supplying a program that implements one or more of the functions of the above embodiments to a system or device via a network or a storage medium, and causing one or more processors in the computer of the system or device to read and execute the program. Moreover, it can also be realized by a circuit (for example, an application specific integrated circuit (ASIC)) that implements one or more functions.

According to the present disclosure, the focus degree is quantified through frequency analysis that takes visual characteristics into account, and determination is performed using image capture information. As a result, the focus degree can be evaluated using the same index under various conditions.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., an ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., a CPU or a micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-205434, filed Nov. 26, 2024, which is hereby incorporated by reference herein in its entirety.

What is claimed is:

1. An image processing apparatus comprising:
at least one processor; and
at least one memory having stored thereon instructions which, when executed by the at least one processor, cause the image processing apparatus at least:
to input image data of a captured image;
to calculate a value indicating a focus degree of an object included in the image based on image capture information during a process for capturing the image with respect to the input image data;
to output the value indicating the focus degree; and
to perform determination of a focus state of the object based on the value indicating the focus degree.

2. The image processing apparatus according to claim 1, wherein executing the stored instructions by the at least one processor further causes the image processing apparatus to output a determination result of the determination along with the value indicating the focus degree or output the determination result instead of the value indicating the focus degree.

3. The image processing apparatus according to claim 1, wherein executing the stored instructions by the at least one processor further causes the image processing apparatus to: determine the focus state in a plurality of levels; and change a determination threshold of the plurality of levels in accordance with the image capture information.

4. The image processing apparatus according to claim 1, wherein executing the stored instructions by the at least one processor further causes the image processing apparatus to: detect the object from the image; and extract an area on the image including the object.

5. The image processing apparatus according to claim 4, wherein executing the stored instructions by the at least one processor further causes the image processing apparatus to: convert the area into a frequency area; and calculate the value indicating the focus degree by executing a filtering process according to visual characteristics with respect to the frequency area obtained by the conversion.

6. The image processing apparatus according to claim 5, wherein executing the stored instructions by the at least one processor further causes the image processing apparatus to: execute the filtering process in accordance with the visual characteristics and the image capture information; and calculate the value indicating the focus degree.

7. The image processing apparatus according to claim 6, wherein executing the stored instructions by the at least one processor further causes the image processing apparatus to: calculate the focus degree based on a difference between image data indicating the area and image data after the filtering process is executed.

8. The image processing apparatus according to claim 1, wherein executing the stored instructions by the at least one processor further causes the image processing apparatus to calculate the value indicating the focus degree using a machine learning model trained under a learning condition according to the image capture information.

9. The image processing apparatus according to claim 1, wherein the object is a living organism or a specific part of the living organism.

10. The image processing apparatus according to claim 1, wherein the image capture information includes a number of pixels of the area in a vertical direction or a horizontal direction, a lens characteristic of an interchangeable lens unit used upon capturing the image, or both.

11. The image processing apparatus according to claim 1, further comprising a display unit configured to display at least information for identifying the image and the value indicating the focus degree in association with each other,
wherein the display unit switches display content based on the image capture information, and displays the display content.

12. The image processing apparatus according to claim 2, further comprising a display unit configured to display at least information for identifying the image and the value indicating the focus degree in association with each other,
wherein executing the stored instructions by the at least one processor further causes the image processing apparatus to:
input data of a plurality of images captured using a plurality of interchangeable lens units; and
perform determination of the focus state independent of the interchangeable lens unit and perform determination of the focus state for each interchangeable lens unit with respect to the data of the plurality of images, and
wherein the display unit is configured to display a result of the determination of the focus state independent of the interchangeable lens unit and a result of the determination of the focus state for each interchangeable lens unit by switching the result therebetween.

13. An image processing method to be executed by an image processing apparatus, the method comprising:
inputting image data of a captured image;
calculating a value indicating a focus degree of an object included in the image based on image capture information during a process for capturing the image with respect to the input image data;
outputting the calculated value indicating the focus degree; and
determining a focus state of the object based on the value indicating the focus degree.

14. A non-transitory storage medium storing a program of an image processing apparatus, causing a computer to perform each step of an image processing method to be executed by the image processing apparatus, the method comprising:
inputting image data of a captured image;
calculating a value indicating a focus degree of an object included in the image based on image capture information during a process for capturing the image with respect to the input image data;
outputting the calculated value indicating the focus degree; and
determining a focus state of the object based on the value indicating the focus degree.
